(19) United States
(12) Patent Application Publication
(10) Pub. No.: US 2026/0099639 A1
(43) Pub. Date: Apr. 9, 2026

(54) CALCULATION, PLANNING, AND CONFIGURATION METHOD FOR MAXIMUM LATENCY OF POWER DISTRIBUTION NETWORK INTEGRATED WITH IDC

(71) Applicants: Tianjin University, Tianjin (CN); China Electric Power Research Institute, Beijing (CN)

(72) Inventors: Qian XIAO, Tianjin (CN); Tianxiang LI, Nankai District (CN); Hongjie JIA, Tianjin (CN); Yunfei MU, Tianjin (CN); Yu JIN, Tianjin (CN); Wenbiao LU, Tianjin (CN); Huqiao LIU, Tianjin (CN); Xiaodan YU, Tianjin (CN); Ji QIAO, Beijing (CN); Tianjiao PU, Beijing (CN)

(73) Assignees: Tianjin University, Tianjin (CN); China Electric Power Research Institute Co., Ltd., Beijing (CN)

(21) Appl. No.: 19/258,012

(22) Filed: Jul. 2, 2025

(30) Foreign Application Priority Data
Jul. 3, 2024 (CN) 202410883458X

(51) Int. Cl. G06F 30/18; G06F 113/02; G06F 113/04

(52) U.S. Cl. CPC G06F 30/18; G06F 2113/02; G06F 2113/04

(57) ABSTRACT

The present invention discloses a calculation, planning, and configuration method for a maximum latency of a power distribution network for an Internet data center (IDC): first, proposing an information element model of an analog circuit, specifically including an information current, an information voltage, an information resistance, and an information conductance; then, building an equivalent circuit model of the information system for the power distribution network for the IDC based on the basic element model; next, building an information current and information voltage constraint model based on the equivalent circuit model; then, calculating a maximum latency of the power distribution network for the IDC in consideration of channel congestion and a load priority; and finally, formulating a planning and configuration solution for the IDC in the power distribution network to minimize a maximum latency of an entire system.

### FIELD OF TECHNOLOGY

The present invention relates to calculation of a power distribution network for an Internet data center (IDC), and a planning and configuration method for an analog circuit model and the IDC, and in particular to a calculation, planning, and configuration method for a maximum Latency of the power distribution network integrated with IDC.

### BACKGROUND

The IDC is a large-scale centralized information processing facility used for storage and computing. With the increasing demand of people for data communication and data processing, the IDC plays an increasingly important role. Usually, the IDC collects data from an information system, processes user computing tasks, and distributes computing results to various users. This process results in computation and transmission latency, and magnitudes of the latency directly affect the quality of user service. In addition, the IDC is powered by a power distribution network, and a planned configured capacity of the IDC directly influences a power flow of the power distribution network, thereby exacerbating energy losses in power lines.

At present, existing models are unable to accurately and quickly calculate a maximum latency of the IDC, so it is difficult to carry out IDC planning and configuration based on actual demands of the users and the power distribution networks.

### SUMMARY

The present invention is intended to quickly and accurately calculate a maximum latency of a power distribution network for an IDC through an analog circuit model, and provide an information system planning and configuration method in consideration of the maximum latency, which are specifically described as follows:

A calculation, planning, and configuration method for a maximum latency of a power distribution network for an IDC includes the following steps:
proposing an information element model of an analog circuit;
building an equivalent circuit model of an information system for a power distribution network for the IDC based on the basic element model;
building an information current and information voltage constraint model based on the equivalent circuit model;
calculating a maximum latency of the power distribution network for the IDC in consideration of channel congestion and a load priority; and
formulating a planning and configuration solution for the IDC in the power distribution network to minimize a maximum latency of an entire system.

Further, the information element model of the analog circuit is specifically:

The following information element models are built through the analog circuit:

A model of the information current I′ is built as follows:

$${I}^{′} = \frac{{q}^{′}}{t}$$

where q′ is an amount of information generated at a time point t.

A model of the information voltage U′ is built as follows:

$${U}^{′} = \frac{{I}^{′}}{{Y}^{′}} = \frac{{q}^{′}}{{tY}^{′}} = \frac{T}{t}$$

where Y′ is the information conductance, and a value thereof represents an information transmission and processing speed of a communication line or the IDC; T is a time for processing the information; and U′ represents a ratio of the information processing time to a generation time. It is stipulated that tis a unit time. When tis the unit time, U′ is numerically equal to the information processing time.

A model of the information resistance R′ is built as follows:

$${R}^{′} = \frac{1}{{Y}^{′}}$$

where R′ is a time for processing unit information.

Further, the building an equivalent circuit model of an information system for a power distribution network for the IDC based on the basic element model is specifically as follows:

It is assumed that the power distribution network for the IDC as shown in FIG. 3 exists, there are two users with a priority of 1, one user with a priority of 2, and one IDC in the information system (it is stipulated that the IDC prioritizes processing users with a higher priority). Based on the above definitions of the basic information elements, the following conversion can be performed.

User: Each user can be equivalent to one information current source and one information resistance. The information current source represents an amount of information generated by the user, and the information resistance represents an information uploading speed of the user.

Communication line: Each communication line can be represented as one information resistance, and the information resistance represents an information transmission speed of this communication line.

IDC: the IDC can be represented as one information resistance, and the information resistance represents an information processing speed of the IDC.

Further, the building an information current and information voltage constraint model based on the equivalent circuit model is specifically as follows:
information current constraint: for a specific information node, information currents flowing into and out of the node are numerically equal if information conversion, such as encoding and decoding, is not considered;
information voltage constraint: for a specific communication network, when there are different communication paths from one node to the other, a total time for information currents to pass through different paths is the same. This indicates that the transmission solutions for different communication paths have been optimized in advance to minimize the total transmission time.

Further, the calculating a maximum latency of the power distribution network for the IDC in consideration of channel congestion and load priority is specifically as follows:
first, based on the method proposed in the patent, converting the information system for the power distribution network for the IDC shown in FIG. 3(a) into an analog circuit model shown in FIG. 3(b), and calculating an information voltage at each node, with a calculation result of a maximum latency borne by the user under an extreme adverse condition; and
Second, correcting a calculation result of the maximum latency of a user with a high priority. Because an information processing requirement of a user with a high priority needs to be prioritized, when user 2 and user 3 with the high priority are calculated, a communication line of user 1 as shown in FIG. 3(c) needs to be interrupted, the information voltage is recalculated, and the result of step (1) is corrected.

Further, the formulating a planning and configuration solution for the IDC in the power distribution network to minimize a maximum latency of an entire system is specifically as follows:

The maximum latency of the entire system is calculated in the method of the patent. A planned target is to minimize the maximum latency and power loss, and planning and configuration of the IDC in the power distribution network are performed.

Beneficial effects of the technical solutions provided in the present invention:

(1) Compared with a traditional information system model, the present invention converts the information system model into a circuit model, which helps power dispatch personnel understand operating rules of the information system and can assist in improving the effectiveness of power system optimization and scheduling.

(2) Compared with a traditional maximum transmission latency calculation method, the method proposed in the present invention considers the user priority and channel congestion, and conducts maximum latency calculation in the form of the analog circuit, resulting in higher calculation accuracy and smaller computational complexity.

(3) Compared with a traditional IDC planning and configuration method, the present invention can significantly reduce power flow losses and IDC maximum latency in the power distribution network.

### BRIEF DESCRIPTION OF THE DRAWINGS

FIG. 1 is a flowchart of a calculation, planning, and configuration method for a maximum latency of a power distribution network for an IDC;

FIG. 2 is a typical power distribution network architecture for the IDC;

FIG. 3 is an information processing model;

FIG. 3(a) is an example of an information system, FIG. 3(b) is an analog circuit model, and FIG. 3(c) is an analog circuit model in consideration of a user priority;

FIG. 4 is a diagram of a simulated scenario of the power distribution network for the IDC based on IEEE 33 nodes; and

FIG. 5 is a comparison result between the maximum latency calculated by the proposed method and an actual latency range.

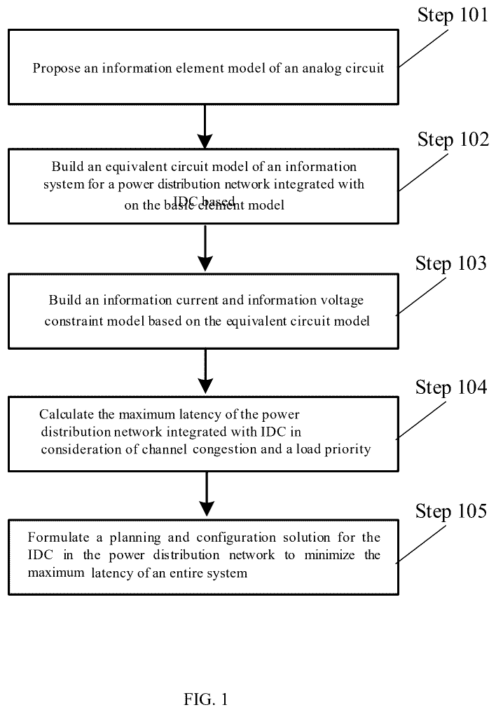

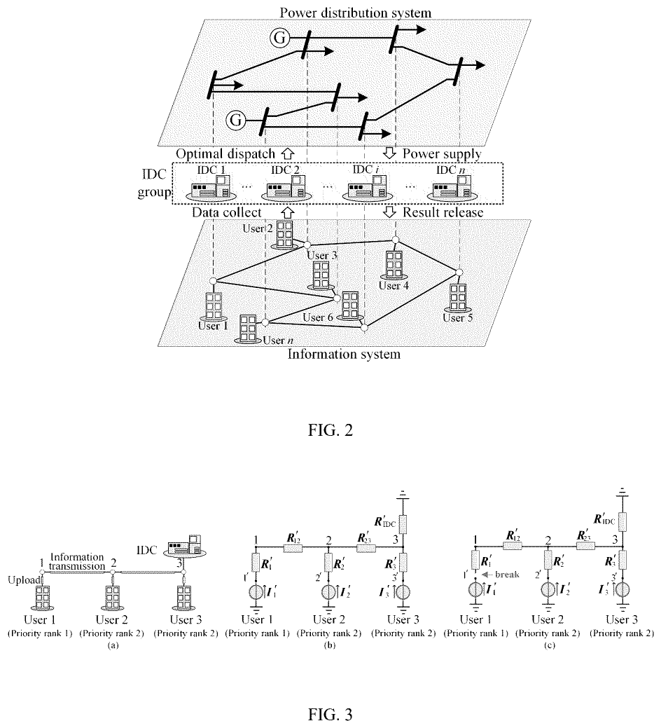

### DESCRIPTION OF THE EMBODIMENTS

To make the purpose, technical solutions, and advantages of the present invention clearer, implementations of the present invention are further described below.

### Embodiment 1

A calculation, planning, and configuration method for a maximum latency of a power distribution network for an IDC includes the following steps.

Step 101: Propose an information element model of an analog circuit, specifically including an information current, an information voltage, an information resistance, and an information conductance.

The present invention proposes the following information element models based on the analog circuit, as shown in Table 1:

TABLE 1
Information Element Model of an Analog Circuit

| Circuit element | Information element |
|---|---|
| Current I | Information current I′ |
| Resistance R | Information resistance R′ |
| Conductance Y | Information conductance Y′ |
| Voltage U | Information voltage U′ |

A model of the information current l′ is built as follows:

$${I}^{′} = \frac{{q}^{′}}{t} \qquad ( 1 )$$

where q′ is an amount of information generated at a time point t.

A model of the information voltage U′ is built as follows:

$${U}^{′} = \frac{I ′}{Y ′} = \frac{q ′}{tY ′} = \frac{T}{t} \qquad ( 2 )$$

where Y′ is the information conductance, and a value thereof represents an information transmission and processing speed of a communication line or the IDC; T is a time for processing the information; and it can be obtained, through mathematical calculations, that U′ represents a ratio of the information processing time to a generation time. When t is a unit time, U′ is numerically equal to the information processing time. Therefore, in the present invention, it is specified that/is the unit time.

A model of the information resistance R′ is built as follows:

$${R}^{′} = \frac{1}{Y ′} \qquad ( 3 )$$

where R′ is a time for processing unit information.

Step 102: Build an equivalent circuit model of the information system for the power distribution network for the IDC based on the basic element model.

It is assumed that the power distribution network for the IDC shown in FIG. 3 exists, there are two users with a priority of 1, one user with a priority of 2, and one IDC in the information system (it is stipulated that the IDC prioritizes processing users with a higher priority). Based on the above definitions of the basic information elements, the following conversion can be performed:

User: Each user can be equivalent to one information current source and one information resistance. The information current source represents an amount of information generated by the user, and the information resistance represents an information uploading speed of the user.

Communication line: Each communication line can be represented as one information resistance, and the information resistance represents an information transmission speed of this communication line.

IDC: the IDC can be represented as one information resistance, and the information resistance represents an information processing speed of the IDC.

In the above method, an actual information system shown in FIG. 3(a) can be converted into a circuit analogy model shown in FIG. 3(b). In FIG. 3(b), U′ at a node 1′ represents a maximum latency of a user 1, and a calculation method for other users is similar.

Step 103: Build an information current and information voltage constraint model based on the equivalent circuit model.

To resolve the information system circuit model built in step 102, the present invention proposes the following information current and information voltage constraint model:

Constraint of information current: for a specific information node, information currents flowing into and out of the node are numerically equal if information conversion such as encoding and decoding, is not considered, which can be represented by the following formula:

$${\sum }_{Ω} {I}^{′} = {\sum }_{ω} {I}^{′} \qquad ( 4 )$$

where Ω represents a set of information currents flowing into the node; ω is a set of information currents flowing out of the node.

Constraint of information voltage: For a specific communication network, when there are different communication paths from one node to the other, a total time for information currents to pass through different paths is the same. This indicates that the transmission solutions for different communication paths have been optimized in advance to minimize a total transmission time. which can be represented by the following formula:

$${\sum }_{ϕ} {U}^{′} = 0 \qquad ( 5 )$$

where φ is a set of information voltages on an information loop.

Step 104: Calculate a maximum latency of the power distribution network for the IDC in consideration of channel congestion and a load priority.

Calculation of the maximum latency is divided into two steps in consideration of a priority of user information processing:

An information voltage at each node in FIG. 3(b) is calculated, and a result is as follows:

$$\{ \begin{matrix}{U}_{( {1}^{′} )}^{′} = {I}_{1}^{′} ( {R}_{1}^{′} + {R}_{12}^{′} + {R}_{23}^{′} + {R}_{IDC}^{′} ) + {I}_{2}^{′} ( {R}_{2}^{′} + {R}_{23}^{′} + {R}_{IDC}^{′} ) + {I}_{3}^{′} {R}_{IDC}^{′} \\ {U}_{( {2}^{′} )}^{′} = {I}_{1}^{′} ( {R}_{23}^{′} + {R}_{IDC}^{′} ) + {I}_{2}^{′} ( {R}_{2}^{′} + {R}_{23}^{′} + {R}_{IDC}^{′} ) + {I}_{3}^{′} {R}_{IDC}^{′} \\ {U}_{( {3}^{′} )}^{′} = {I}_{1}^{′} {R}_{IDC}^{′} + {I}_{2}^{′} {R}_{IDC}^{′} + {I}_{3}^{′} ( {R}_{3}^{′} {R}_{IDC}^{′} )\end{matrix} \qquad ( 6 )$$

A calculation result of formula (6) represents a maximum congestion time that the user can tolerate, which means that when any given user uses any communication line and IDC, other users need to perform tasks thereof before this user. In an actual information network, the above extreme scenario mentioned above may occur due to a fact that information from different users is generated at different time points.

Because an information processing requirement of a user with a high priority needs to be prioritized, when user 2 and user 3 with the high priority are calculated, a communication line of user 1 as shown in FIG. 3(c) needs to be interrupted, the information voltage is recalculated, and the result of step (1) is corrected. A modified result is as follows:

$$\{ \begin{matrix}{U}_{( {1}^{′} )}^{′} = {I}_{1}^{′} ( {R}_{1}^{′} + {R}_{12}^{′} + {R}_{23}^{′} + {R}_{IDC}^{′} ) + {I}_{2}^{′} ( {R}_{2}^{′} + {R}_{23}^{′} + {R}_{IDC}^{′} ) + {I}_{3}^{′} {R}_{IDC}^{′} \\ {U}_{( {2}^{′} )}^{′} = {I}_{2}^{′} ( {R}_{2}^{′} + {R}_{23}^{′} + {R}_{IDC}^{′} ) + {I}_{3}^{′} {R}_{IDC}^{′} \\ {U}_{( {3}^{′} )}^{′} = {I}_{2}^{′} {R}_{IDC}^{′} + {I}_{3}^{′} ( {R}_{3}^{′} {R}_{IDC}^{′} )\end{matrix} \qquad ( 7 )$$

When more priorities are to be divided, step (2) is repeated for each priority, so that an accurate maximum latency time can be calculated.

Step 105: Formulate a planning and configuration solution for the IDC in the power distribution network to minimize a maximum latency of an entire system.

The maximum latency of the entire system is calculated in the method of the patent. A planned target is to minimize the maximum latency and power losses, and planning and configuration of the IDC in the power distribution network are performed.

### (1) Target Function

$$y = min ( a {\sum }_{i = 1}^{n} {U}_{( i ′ )}^{′} + bC ) \qquad ( 8 )$$

where n is a quantity of nodes in the power distribution network for the IDC;

$${U}_{( i ′ )}^{′}$$

is an information voltage or a node i calculated by formula (7), which is numerically equal to a maximum calculated latency at each node; C is a construction cost for the IDC; and a and b are weight coefficients.

The construction cost for the IDC can be calculated through the following formula:

$$C = {\sum }_{i = 1}^{n} ( {δ}_{i} {C}_{1} + {δ}_{i} {Q}_{i} {C}_{2} ) \qquad ( 9 )$$

where δᵢ is a node identifier, with a value thereof can be only 0 or 1, a value of “0” indicates that no IDC is built at the node, and a value of “1” indicates that the IDC is built at the node; C₁ represents construction costs for the IDC, which usually includes a site cost, a housing construction cost, and the like; and C₂ represents a unit capacity configuration price of an IDC computing device, and Qᵢ represents a IDC capacity built at the node i.

### (2) Constraint Condition

### (1) Constraint on Installing Capacity

$${Q}_{i} \leq {Q}_{i}^{max} \qquad ( 10 )$$

where

$${Q}_{i}^{max}$$

represents a maximum we capacity allowed to be installed at the node i.

### (2) Site Selection Solution Constraint

$$\{ \begin{matrix}{δ}_{i} = 0 \\ {δ}_{i} = 0 or 1\end{matrix} \begin{matrix}construction of the IDC is not allowed at the node i \\ construction of the IDC is allowed at the node i\end{matrix} \qquad ( 11 )$$

where when the construction of the IDC is not allowed at the node i, δᵢ can be only 0; or when the construction of the IDC is allowed at the node i, δᵢ can be 0 or 1.

### Embodiment 2

Specific embodiments are provided as follows to verify the feasibility of the above method, which is specifically described as follows:

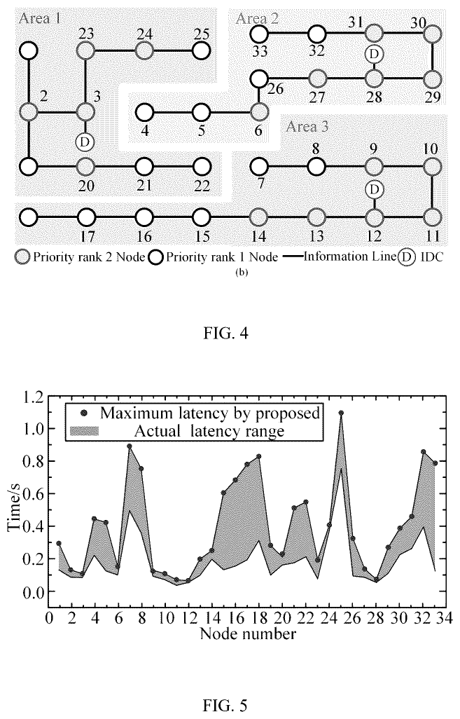

To verify the effectiveness of the maximum latency calculation method, the present invention conducts simulation on an IEEE 33 node network, as shown in FIG. 4. In addition, to ensure data integrity when information is transmitted to the IDC, the network is effectively divided into three regions, and each region is managed by a separate IDC.

In the simulation of the above scenario, the comparison between the maximum latency calculated in the proposed method and an actual latency range is shown in FIG. 5. It can be learned that the maximum latency calculated in the proposed method is extremely approximate to an actual maximum latency.

In addition, using the method in the present invention to calculate the maximum latency of the information system with n nodes is equivalent to solving a linear equation system with n variables, with a relatively small computational amount.

All or some of the foregoing embodiments may be implemented by using software, hardware, firmware, or any combination thereof. When the software is used for implementation, all or some of the embodiments may be implemented in the form of a computer program product. The computer program product includes one or more computer instructions. When the computer program instructions are loaded and executed on a computer, all or some procedures or functions in the embodiments of the present invention are generated.

The computer may be a general-purpose computer, a dedicated computer, a computer network, or another programmable apparatus. The computer instructions may be stored in a computer-readable storage medium or may be transmitted through a computer-readable storage medium. The computer-readable storage medium may be any usable medium accessible by a computer, or a data storage device, such as a server or a data center, integrating one or more usable media. The usable medium may be a magnetic medium or a semiconductor medium.

Embodiments of the present invention specifically describe models of each device and do not limit models of other devices, as long as the devices can perform the above functions.

Those skilled in the art can understand that the drawings are only schematic diagrams of a preferred embodiment, and serial numbers of the above embodiments of the present invention are only for description and do not represent the advantages and disadvantages of the embodiments.

The above descriptions are only preferred embodiments of the present invention and are not used to limit the present invention. Any modifications, equivalent substitutions, improvements, and the like made within the spirit and principle of the present invention should be included within the protection scope of the present invention.

What is claimed is:

1. A calculation, planning, and configuration method for a maximum latency of a power distribution network for an Internet data center (IDC), wherein the method comprises:
proposing an information element model of an analog circuit, specifically comprising an information current, an information voltage, an information resistance, and an information conductance;
building an equivalent circuit model of an information system for the power distribution network for the IDC based on the basic element model;
building an information current and information voltage constraint model based on the equivalent circuit model;
calculating a maximum latency of the power distribution network for the IDC in consideration of channel congestion and a load priority; and
formulating a planning and configuration solution for the IDC in the power distribution network to minimize a maximum latency of an entire system.

2. The calculation, planning, and configuration method for a maximum latency of a power distribution network for an IDC according to claim 1, wherein the proposing an information element model of an analog circuit is specifically as follows:
building the following information element models through the analog circuit:
a model of the information current I\hat{ }′ is built as follows:
$$I {\hat{}}^{′} = q {\hat{}}^{′} / t$$
wherein q\hat{ }′ is an amount of information generated at a time point t;
a model of the information voltage UN′ is built as follows:
$$U {\hat{}}^{′} = I {\hat{}}^{′} / Y {\hat{}}^{′} = q {\hat{}}^{′} / ( tY {\hat{}}^{′} ) = T / t$$
wherein Y\hat{ }′ is the information conductance, and a value thereof represents an information transmission and processing speed of a communication line or the IDC; T is a time for processing the information; U\hat{ }′ represents a ratio of the information processing time to a generation time; and when t is a unit time, U\vec{ }′ is numerically equal to the information processing time;
a model of the information resistance R\hat{ }′ is built as follows:
$$R {\hat{}}^{′} = 1 / Y {\hat{}}^{′}$$
wherein R\hat{ }′ is a time for processing unit information.

3. The calculation, planning, and configuration method for a maximum latency of a power distribution network for an IDC according to claim 1, wherein the information current and information voltage constraint model based on the equivalent circuit model is specifically as follows:
for the power distribution network for the IDC, there are two users with a priority 1, one user with a priority 2, and one IDC in the information system, and the IDC prioritizes processing users with a higher priority, and the following conversion is performed based on a definition of a basic information element:
user: each user can be equivalent to one information current source and one information resistance, wherein the information current source represents an amount of information generated by the user, and the information resistance represents an information uploading speed of the user;
communication line: each communication line can be represented as one information resistance, and the information resistance represents an information transmission speed of this communication line;
IDC: the IDC can be represented as one information resistance, and the information resistance represents an information processing speed of the IDC;

4. The calculation, planning, and configuration method for a maximum latency of a power distribution network for an IDC according to claim 1, wherein information current and information voltage constraint model based on the equivalent circuit model is specifically as follows:
information current constraint: for a specific information node, information currents flowing into and out of the node are numerically equal if information conversion, such as encoding and decoding, is not considered;
information voltage constraint: for a specific communication network, when there are different communication paths from one node to the other, a total time for information currents to pass through different paths is the same, which represents that transmission solutions for different communication paths are optimized, thereby minimizing a total transmission time.

5. The calculation, planning, and configuration method for a maximum latency of a power distribution network for an IDC according to claim 1, wherein the calculating a maximum latency of the power distribution network for the IDC in consideration of channel congestion and a load priority is specifically:
first, converting the information system for the power distribution network for the IDC into an analog circuit model, and calculating an information voltage at each node, with a calculation result of a maximum latency borne by the user under an extreme adverse condition; and
second, correcting a maximum latency calculation result for a user with a high priority, wherein because an information processing requirement of the user with a high priority needs to be prioritized, when user 2 and user 3 with a high priority are calculated, a communication line of user 1 needs to be interrupted, the information voltage is recalculated, and a result of the maximum latency is corrected.

6. The calculation, planning, and configuration method for a maximum latency of a power distribution network for an IDC according to claim 1, wherein the formulating a planning and configuration solution for the IDC in the power distribution network to minimize a maximum latency of an entire system is specifically:
calculating the maximum latency of the entire system, minimizing the maximum latency and power loss as a planned target, and performing planning and configuration of the IDC in the power distribution network.
